(19) United States
(12) Patent Application Publication
(10) Pub. No.: US 2026/0151894 A1
(43) Pub. Date: Jun. 4, 2026

(54) ROBOT

(71) Applicant: LG ELECTRONICS INC., Seoul (KR)

(72) Inventor: Kyeongtae KIM, Seoul (KR)

(73) Assignee: LG ELECTRONICS INC., Seoul (KR)

(21) Appl. No.: 19/126,335

(22) PCT Filed: May 23, 2023
(86) PCT No.: PCT/KR2023/006980

§ 371 Date: May 1, 2025

(30) Foreign Application Priority Data
Nov. 2, 2022 (KR) 10-2022-0144528

(51) Int. Cl. B25J 5/00; B25J 9/16; B25J 19/00

(52) U.S. Cl. CPC B25J 5/007; B25J 9/1661; B25J 9/1664; B25J 19/005

(57) ABSTRACT

The present disclosure relates to a robot configured to set the probability that a user exists in each region and to create an efficient movement route on the basis of the probability when the robot moves toward the target user. An embodiment of the present disclosure may provide a robot including a robot main body configured to accommodate a battery therein, a wheel part disposed below the robot main body and configured to move the robot main body in a house while rotating, a sensor part disposed on the robot main body and configured to detect a user located outside the robot main body, a memory disposed in the robot main body and configured to store location probabilities indicating probabilities that a plurality of pre-registered users are located in distinguished regions in the house, and a controller disposed in the robot main body and configured to update the location probability depending on whether the user is detected at a current location.

### TECHNICAL FIELD

The present disclosure relates to a robot and a method of controlling the same. More specifically, the present disclosure relates to a robot configured to set the probability that a user exists in each region and to create an efficient movement route on the basis of the probability instead of moving while searching for a target user each time the robot moves toward the target user.

### BACKGROUND ART

Recently, with the development of robot technology, the use of robots has increased not only in industrial fields but also in homes.

Household robots include robots that perform household chores such as housecleaning or controlling household electrical appliances on behalf of humans, robots that act as users' assistants or provide users with education using artificial intelligence (AI), or robots that replace pets.

The robots include robots configured to perform functions while being stationary at a particular position, and mobile robots that may move. In particular, in the case of the robots used at home, mobile robots, which replace the users or move around the houses while following the users, are mainly used.

Among the mobile robots, a two-wheeled robot having two wheels has an advantage of occupying a small ground surface area and being easy to store and an advantage of being easy to use in the house having a relatively small space because the robot has a small rotation radius when the robot switches between directions.

One of the important functions performed by the household robot to assist the user is a function of delivering items. For example, the user may instruct the robot located in a main bedroom to bring a mobile phone, which is placed on an upper surface of a main body of the robot, to a living room. For example, the user may instruct the robot to take a beverage can or bottle from a refrigerator, place the beverage can or bottle on the upper surface of the main body of the robot, and then deliver the beverage can or bottle to another family member distant from the user.

In case that the robot performs an instruction to deliver an item or simply responds to the user's call instruction as described above, the robot needs to move toward the user (hereinafter, referred to as a ‘target user’) who has called the robot or is related to the execution of the instruction.

In this case, in case that the robot searches for the target user each time the robot is intended to reach the target user, there may occur a problem in that a response to the instruction is delayed, and a battery is discharged because the amount of movement of the robot increases.

In this regard, Korean U.S. Pat. No. 2,040,340 will be described as a preceding document.

The preceding document relates to a system for searching for a call recipient by using a robot, and the system includes a location tracking module that tracks a target person. The preceding document is characterized in that in case that an identified person is not the target person, the location tracking module inquires the identified person about a location of the target person and moves while searching for the target person on the basis of the location.

The preceding document has an effect of more effectively searching for the target person in comparison with the related art but has a limitation in that the robot inevitably moves arbitrarily to another space because there is no basis of searching for the target person in case that no person is found at a current location.

### DISCLOSURE

### Technical Problem

The present disclosure has been made in an effort to solve the above-mentioned problem, and an object of the present disclosure is to efficiently create a robot movement route along which the robot is intended to reach a target user.

### Technical Solution

In order to achieve the above-mentioned object, one embodiment of the present disclosure provides a robot including: a robot main body configured to accommodate a battery therein; a wheel part disposed below the robot main body and configured to move the robot main body in a house while rotating; a sensor part disposed on the robot main body and configured to detect a user located outside the robot main body; a memory disposed in the robot main body and configured to store location probabilities indicating probabilities that a plurality of pre-registered users are located in distinguished regions in the house; and a controller disposed in the robot main body and configured to update the location probability depending on whether the user is detected at a current location.

The controller may create a movement route along which the robot visits the regions in descending order of the location probability for a target user when the robot moves toward the target user related to an instruction to be executed.

The controller may maintain a value made by adding up the location probabilities of the distinguished regions as 100% when the location probability is updated.

When the user is detected by the sensor part in the current region in which the robot main body is located, the controller may update the location probability for the detected user in the current region to 100%.

When the user is not detected by the sensor part in the current region in which the robot main body is located, the controller may update the location probability for the user, who is not detected, in the current region to 0%.

When the location probability of the current region is updated to 0%, the controller may perform the update by increasing the location probabilities of the remaining spaces excluding the current region by the same amount.

When the highest location probability for any particular user is lower than a preset value, the controller may move the robot main body by controlling the wheel to directly search for the corresponding user and update the location probability.

The controller may move the robot main body by controlling the wheel to directly search for any user and update the location probability each time a preset period of time elapses.

When all the location probabilities for any user in the distinguished regions are 0%, the controller may determine a location of the corresponding user as a non-identifiable state.

The controller may designate a main region having the highest probability that the user is located, and the controller may apply different ratios to the increase or decrease in the location probability between the main region and another region when the location probability is updated for each user.

When the robot moves toward a target user related to an instruction to be executed, the controller may update the location probability by using voice recognition when an inaccessible region is present in the distinguished regions.

### Advantageous Effects

According to the present disclosure, the location probabilities indicating the probabilities that the plurality of pre-registered users are located in the distinguished regions in the house are stored, such that the movement route for the robot may be created on the basis of the stored location probability when the target user is determined. Therefore, it is possible to quickly execute the instruction and reduce the amount of consumption of the battery in comparison with a case in which the robot moves to search for the target user each time.

In addition, according to the present disclosure, the location probability for the corresponding user in the current region is updated in case that the robot detects or does not detect the user while moving or being on standby. Therefore, the accuracy of the location probability for the user may be maintained to be high at ordinary times.

### DESCRIPTION OF DRAWINGS

FIG. 1 is a perspective view for explaining a robot according to an embodiment of the present disclosure.

FIG. 2 is a front view of the robot according to the embodiment of the present disclosure.

FIG. 3 is a perspective view of the robot according to the embodiment of the present disclosure when viewed at another angle.

FIG. 4 is a partially cut-away view for explaining transmission of power for rotating an arm of the robot according to the embodiment of the present disclosure.

FIG. 5 is a top plan view of the robot according to the embodiment of the present disclosure.

FIG. 6 is a view for explaining an arm of a robot according to another embodiment of the present disclosure.

FIG. 7 is a view for explaining a state in which an attaching/detaching part of the arm in FIG. 6 is rotated.

FIG. 8 is a bottom plan view of the robot according to the embodiment of the present disclosure.

FIG. 9 is a block diagram for explaining a control configuration of the robot according to the embodiment of the present disclosure.

FIG. 10 is a view for explaining a coupling relationship between a robot mask and a robot main body of the robot according to the embodiment of the present disclosure.

FIG. 11 is a view illustrating one example and illustrating location probabilities of user 1 U1, user 2 U2, and user 3 U3 for each of regions Room 1, Room 2, Room 3, and Room 4.

FIG. 12 is a view illustrating a traveling map indicating regions in a house in which the robot travels in the example situation in FIG. 11 and illustrating locations of registered users.

FIG. 13 is a view illustrating how the location probability is updated depending on whether the robot has recognized the user in the example situation in FIGS. 11 and 12.

### MODE FOR INVENTION

Hereinafter, exemplary embodiments of the present disclosure will be described in detail with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

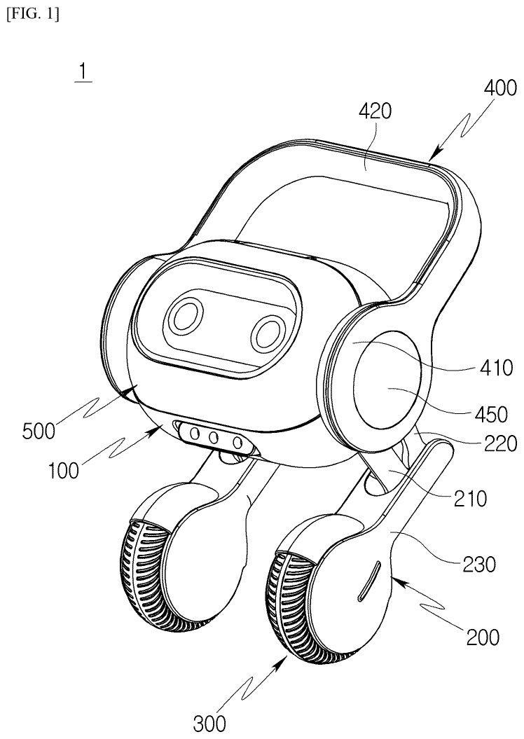

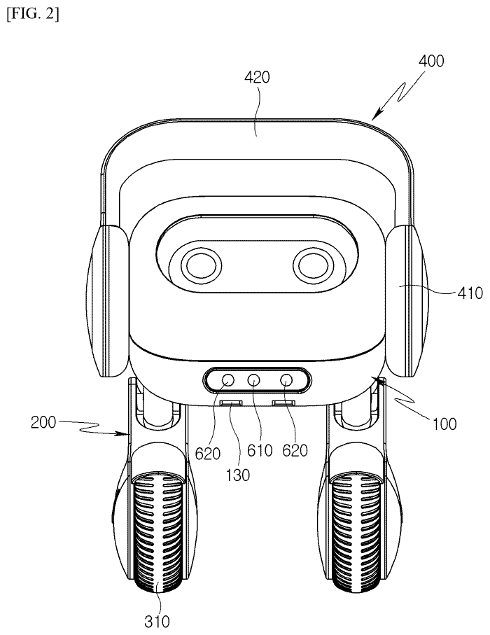

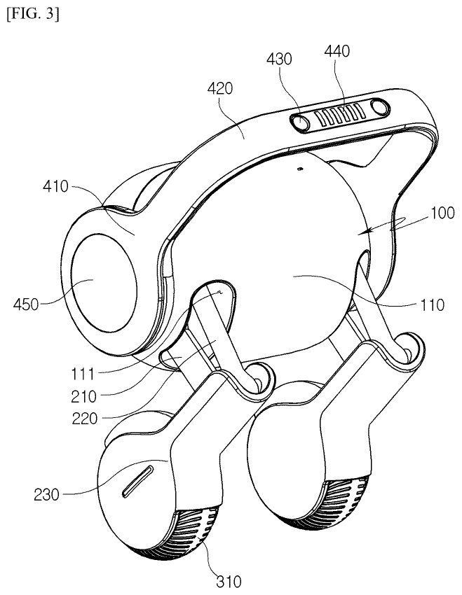

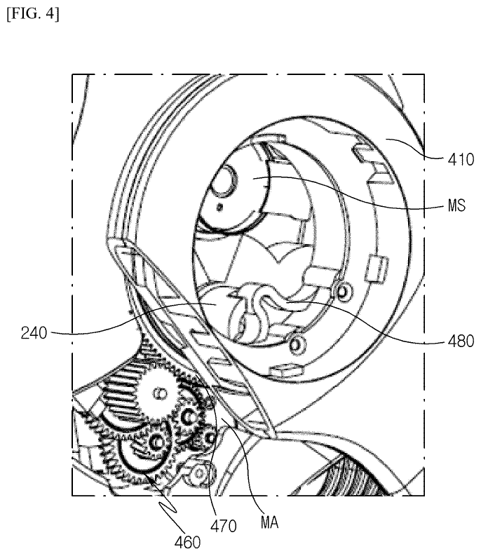

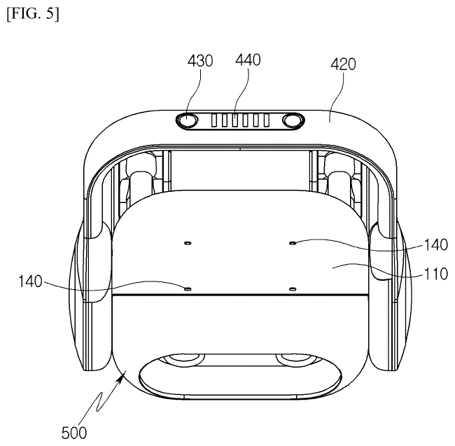

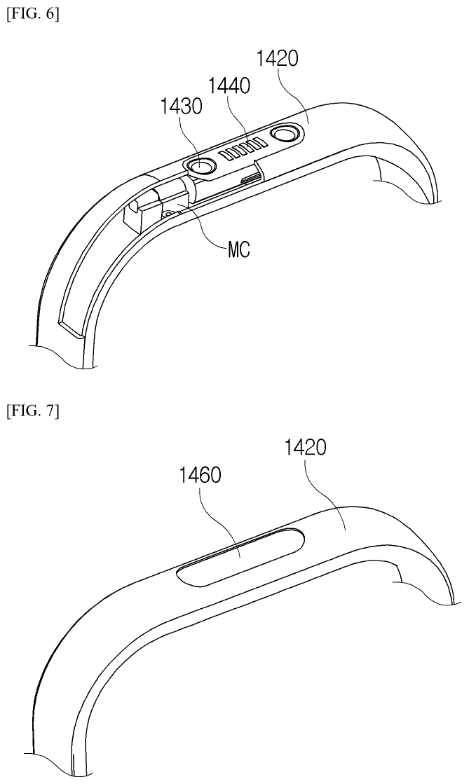

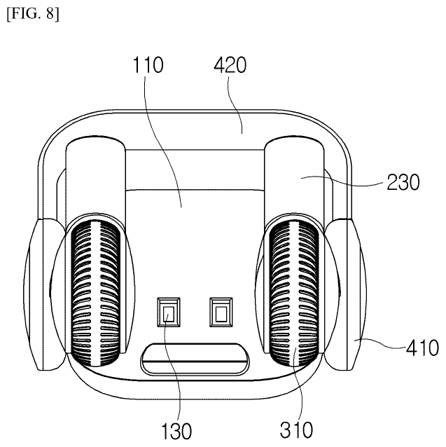

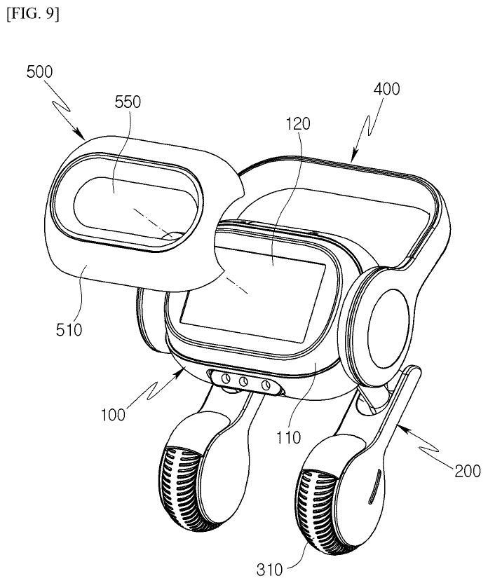

FIG. 1 is a perspective view for explaining a robot according to an embodiment of the present disclosure, FIG. 2 is a front view of the robot according to the embodiment of the present disclosure, FIG. 3 is a perspective view of the robot according to the embodiment of the present disclosure when viewed at another angle, FIG. 4 is a partially cut-away view for explaining transmission of power for rotating an arm of the robot according to the embodiment of the present disclosure, FIG. 5 is a top plan view of the robot according to the embodiment of the present disclosure, FIG. 6 is a view for explaining an arm of a robot according to another embodiment of the present disclosure, FIG. 7 is a view for explaining a state in which an attaching/detaching part of the arm in FIG. 6 is rotated, and FIG. 8 is a bottom plan view of the robot according to the embodiment of the present disclosure.

A robot 1 according to an embodiment of the present disclosure will be described below with reference to FIGS. 1 to 8.

The robot 1 according to the embodiment of the present disclosure is placed on a floor and configured to move along a floor surface B. Therefore, hereinafter, a vertical direction is defined based on a state in which the robot 1 is placed on the floor.

Further, a side at which a first camera 610a to be described below is disposed is defined and described as a front side of the robot 1. In addition, a side opposite to the front side is defined and described as a rear side of the robot 1.

Among the portions described in the embodiment of the present disclosure, a ‘lowermost portion’ may be a portion positioned at a lowest position or a portion closest to the floor when the robot 1 according to the embodiment of the present disclosure is placed on the floor and used.

The robot 1 according to the embodiment of the present disclosure includes a robot main body 100, leg parts 200, wheel parts 300, an arm 400, and a robot mask 500. In this case, the leg parts 200 are coupled to the robot main body 100, and the wheel parts 300 are coupled to the leg parts 200. In addition, the arm 400 is pivotably coupled to two opposite surfaces of the robot main body 100. Further, the robot mask 500 is detachably coupled to the robot main body 100.

### Robot Main Body

The robot main body 100 of the robot 1 according to the embodiment of the present disclosure will be described below with reference to FIGS. 1 to 8.

The components, which constitute the robot 1, may be coupled to the robot main body 100. For example, the robot mask 500 may be detachably coupled to the robot main body 100. In addition, the arm 400 is pivotably coupled to the robot main body 100. The arm 400 is pivotably coupled to two opposite ends of the robot main body 100. The robot main body 100 may be coupled to a functional module by means of the arm 400 and perform an additional function. In addition, with the arm 400, the robot main body 100 may implement a posture in which the robot main body 100 is on standby for power saving or a posture in which the robot main body 100 stands up after falling.

Some of the components, which constitute the robot 1, may be accommodated in the robot main body 100.

A main body housing 110 may define an external shape of the robot main body 100. One or more motors including a suspension motor MS, one or more sensors, and a battery 800 may be accommodated in an internal space of the main body housing 110.

In addition, although not illustrated, at least one bumper may be provided in the main body housing 110.

The bumper may be provided to be movable relative to the main body housing 110. For example, the bumper may be coupled to the main body housing 110 and configured to be reciprocable in a forward/rearward direction of the main body housing 110.

The bumper may be coupled along a part or the entirety of a front rim of the main body housing 110. In addition, the bumper may be disposed at a rear side in the main body housing 110.

With this configuration, in case that the robot 1 collides with another object or a person, the bumper may absorb an impact applied to the robot main body 100 and protect the robot main body 100 and the components accommodated in the robot main body 100.

The pair of leg parts 200 are coupled in the main body housing 110. The pair of leg parts 200 may penetrate the main body housing 110 and be exposed to the outside.

Specifically, a first link 210 and a second link 220 may be rotatably coupled in the main body housing 110. For example, a link frame (not illustrated), to which the first link 210 and the second link 220 are linked, may be provided in the main body housing 110.

Further, the suspension motor MS may be accommodated in the main body housing 110. For example, the suspension motor MS may be disposed on the link frame (not illustrated). The suspension motor MS may be connected to the first link 210.

A pair of leg guide holes 111 may be formed in the main body housing 110. For example, the pair of leg guide holes 111 may be formed side by side in the forward/rearward direction of the main body housing 110.

With this configuration, the leg part 200 may rotate along the leg guide hole 111 and guide a rotational movement range of the leg part 200.

The main body housing 110 has a shape in which a width (or diameter) in a horizontal direction is larger than a height in a vertical direction. For example, the main body housing 110 may have a shape similar to an ellipsoid.

The robot main body 100 may provide an advantageous structure that assists the robot 1 in having a stable structure and allows the robot 1 to move (travel) in a balanced manner.

The robot main body 100 may be disposed vertically above wheels 310 to be described below. A load of the robot main body 100 may be transmitted to the wheels 310 through the leg parts 200, and the wheels 310 may support the leg parts 200 and the robot main body 100. With this configuration, the wheels 310 may stably support a load of the robot main body 100.

The robot main body 100 may include a display 120. The display 120 may be coupled to the main body housing 110. The display 120 may be formed in a flat plate shape. The display 120 may be disposed at a predetermined angle with respect to the ground surface. For example, the display 120 may be disposed at a position directed forward and upward. With this configuration, when the robot 1 approaches a user, the display 120 may be visible to the user when the user looks at the robot 1.

Meanwhile, the display 120 may visually provide the user with information on an operating state of the robot 1.

The display 120 may include any one of a light-emitting diode (LED), a liquid crystal display (LCD), a plasma display panel, and an organic light-emitting diode (OLED).

The display 120 may display information such as information on an operating time of the robot 1 and information on electric power of the battery 800.

According to the embodiment, the display 120 may be an input part 125. That is, a control instruction may be inputted to the display 120 from the user. For example, the display 120 may be a touch screen configured to visually display an operating state and receive a control instruction from the user.

The display 120 may display a facial expression of the robot 1. Alternatively, the display 120 may display pupils of the robot 1. A current state of the robot 1 may be expressed as an anthropomorphic emotion through a facial shape or a pupil shape displayed on the display 120. For example, when the user goes out and returns, a smiling face or smiling eyes may be displayed on the display 120. Therefore, the user has an effect of feeling in communion with the robot 1.

A charging terminal 130 may be disposed on the main body housing 110. For example, the charging terminal 130 may be disposed toward the ground surface. For example, the charging terminal 130 may be disposed to face the ground surface. In another example, the charging terminal 130 may be disposed at a predetermined angle with respect to the ground surface. With this configuration, in case that the robot 1 is coupled to a robot charging stand (not illustrated), the charging terminal 130 may come into contact with a terminal provided on the robot charging stand (not illustrated).

The charging terminal 130 may be electrically connected to the robot charging stand (not illustrated). With this configuration, the robot 1 may receive electric power through the charging terminal 130. The electric power supplied to the charging terminal 130 may be supplied to the battery 800. In addition, the robot 1 may receive an electrical signal through the charging terminal 130. A controller 700 may receive the electrical signal transmitted through the charging terminal 130.

Meanwhile, the first camera 610a may be disposed a front lower side of the main body housing 110. For example, the first camera 610a may be disposed on a centerline passing through a center of the main body housing 110 based on a leftward/rightward direction. With this configuration, the first camera 610a may detect an object or person disposed forward of the robot 1.

In addition, IR sensors 620 may be disposed at a front lower side of the main body housing 110. For example, the pair of IR sensors 620 may be disposed at a predetermined interval in the leftward/rightward direction. With this configuration, the IR sensors 620 may detect a position of a light source configured to emit infrared rays.

The IR sensor 620 may be disposed to be close to the first camera 610a. For example, the first camera 610a may be disposed between the pair of IR sensors 620.

### Leg Part

The leg part 200 of the robot 1 according to the embodiment of the present disclosure will be described below with reference to FIGS. 1 to 8.

The leg part 200 may be coupled to the robot main body 100 and support the robot main body 100. For example, the pair of leg parts 200 are coupled in the main body housing 110. The pair of leg parts 200 may be disposed to be symmetric (linearly symmetric). In this case, at least a part of the leg part 200 may be disposed to be closer to the ground surface than the robot main body 100. The leg parts 200 are disposed to connect the robot main body 100 and the wheels 310.

Therefore, the robot main body 100 may travel in a shape in which the robot main body 100 stands on the ground surface with the pair of leg parts 200. That is, the gravity applied to the robot main body 100 may be supported by the leg parts 200, and a height of the robot main body 100 may be maintained.

The leg part 200 includes the first link 210, the second link 220, and a third link 230. In this case, the first link 210 and the second link 220 are rotatably coupled to the robot main body 100 and the third link 230. That is, the first link 210 and the second link 220 are linked to the robot main body 100 and the third link 230.

The first link 210 is linked to left and right sides in the robot main body 100.

The first link 210 is connected to the suspension motor MS. For example, the first link 210 may be connected directly to a shaft of the suspension motor MS or connected to the shaft of the suspension motor MS through gears. With this configuration, the first link 210 receives driving power from the suspension motor MS.

The first link 210 is formed in a frame shape. The suspension motor MS is connected to one longitudinal side of the first link 210, and the third link 230 is coupled to the other longitudinal side of the first link 210. In this case, one side of the first link 210 connected to the suspension motor MS may be disposed to be farther from the ground surface than the other side coupled to the third link 230.

One side of the first link 210 is coupled to a leg support part (not illustrated) provided in the main body housing 110. The first link 210 may be rotatably coupled to the leg support part. For example, one side of the first link 210 may be formed in a disc shape or a circular plate shape. Therefore, one side of the first link 210 may penetrate the leg support part and be connected to the suspension motor MS.

One side of the first link 210 is connected to the suspension motor MS. For example, one side of the first link 210 may be fixedly coupled to the shaft of the suspension motor MS. With this configuration, when the suspension motor MS operates, one side of the first link 210 may rotate in conjunction with the rotation of the shaft of the suspension motor MS.

The other side of the first link 210 is rotatably coupled to the third link 230. For example, a through-hole may be formed at the other side of the first link 210. The shaft may be rotatably and penetratively coupled to the through-hole. The third links 230 may be coupled to two opposite longitudinal ends of the shaft.

With this configuration, the shaft may define an axis about which the first link 210 and/or the third link 230 rotate. Therefore, the first link 210 and the third link 230 may be connected to be relatively rotatable.

Although not illustrated, the leg part 200 may further include a gravity compensation part. The gravity compensation part compensates for a situation in which the robot main body 100 is moved vertically downward by gravity. That is, the gravity compensation part provides a force for supporting the robot main body 100.

For example, the gravity compensation part may be a torsion spring. The gravity compensation part may be wound to surround an outer side of an outer peripheral surface of the first link 210. Further, one end of the gravity compensation part may be inserted into and fixedly coupled to the first link 210, and the other end of the gravity compensation part may be inserted into and fixedly coupled to the third link 230.

The gravity compensation part applies a force (rotational force) in a direction in which an angle between the first link 210 and the third link 230 increases. For example, two opposite ends of the gravity compensation part are retracted in advance so that the gravity compensation part applies a restoring force in the direction in which an included angle between the first link 210 and the third link 230 increases. Therefore, even though the gravity is applied to the robot main body 100 in the state in which the robot 1 is placed on the ground surface, the included angle between the first link 210 and the third link 230 may be maintained within a predetermined angle range.

With this configuration, it is possible to prevent the robot main body 100 from moving downward toward the ground surface even though the suspension motor MS does not operate. Therefore, the gravity compensation part may provide an effect of preventing a loss of energy caused by the operation of the suspension motor MS and maintaining a height of the robot main body 100 as a predetermined distance or more from the ground surface.

The second link 220 is linked to the left and right sides in the robot main body 100. For example, the second link 220 may be linked to the leg support part (not illustrated) provided in the main body housing 110. That is, the second link 220, together with the first link 210, may be coupled to the leg support part (not illustrated) to which the first link 210 is coupled.

The second link 220 is formed in a frame shape. One longitudinal side of the second link 220 is coupled to the leg support part (not illustrated), and the third link 230 is coupled to the other longitudinal side of the second link 220.

An electric wire may be accommodated in the second link 220. For example, a space in which the electric wire may be accommodated may be formed in the second link 220. Therefore, electric power of the battery 800 may be supplied to the wheel part 300 through the electric wire. Further, it is possible to prevent the electric wire from being exposed to the outside.

One side of the second link 220 is rotatably coupled to the leg support part. For example, although not illustrated, the shaft coupled to the leg support part may be penetratively coupled to one side of the second link 220. A hollow portion may be formed in the shaft. The electric wire may pass through the hollow portion. With this configuration, it is possible to prevent the electric wire, through which electric power is supplied from the battery 800 to wheel motors MW, from being exposed to the outside.

The other side of the second link 220 is rotatably coupled to the third link 230. Specifically, the other end of the second link 220 is rotatably coupled to the third link 230 through the shaft. For example, the other side of the second link 220 may be formed in a disc shape, and the shaft may be penetratively coupled to the other side of the second link 220. Further, the two opposite longitudinal ends of the shaft may be coupled to the third links 230. With this configuration, the shaft may define an axis about which the second link 220 and/or the third link 230 rotates. Therefore, the second link 220 and the third link 230 may be connected to be relatively rotatable.

The third link 230 is linked to the first link 210 and the second link 220 and coupled to the wheel part 300.

The third link 230 is formed in a frame shape. The first link 210 and the second link 220 are coupled to one longitudinal side of the third link 230, and the wheel part 300 is coupled to the other longitudinal side of the third link 230.

One longitudinal side of the third link 230 is linked to the first link 210 and the second link 220. For example, a space may be formed at one side of the third link 230 so that the first link 210 and the second link 220 may be accommodated in the space. That is, one side of the third link 230 may be provided in the form of a pair of frames parallel to each other, and the first link 210 and the second link 220 may be accommodated in the space between the pair of frames.

In this case, two shafts may be disposed side by side between the pair of frames. That is, two opposite ends of each of the two shafts may be coupled to the pair of frames. Further, the shafts may each penetrate the first link 210 and the second link 220. In this case, the first link 210 may be disposed forward and downward of the second link 220. That is, the shaft, which penetrates the first link 210, may be disposed to be closer to the wheel 310 than the shaft that penetrates the second link 220.

Therefore, the first link 210 and the second link 220 may be coupled to be rotatable relative to the third link 230.

The other longitudinal side of the third link 230 is coupled to the wheel part 300. The other longitudinal side of the third link 230 may be formed to cover at least a part of the wheel 310. For example, the other longitudinal side of the third link 230 may be formed to cover a rotation center of the wheel 310, and a space, in which the wheel 310 may be rotatably accommodated, may be formed at the other longitudinal side of the third link 230.

In addition, the wheel motor MW may be accommodated in the third link 230 at the other longitudinal side of the third link 230.

With this configuration, the wheel 310 and the wheel motor MW may be accommodated at the other longitudinal side of the third link 230, and the wheel 310 may be rotatably coupled to the other longitudinal side of the third link 230.

Meanwhile, a sensor capable of measuring a distance from the ground surface may be provided at the other longitudinal side of the third link 230. For example, the sensor may be a ToF sensor (time-of-flight sensor). With this configuration, the controller 700 may determine whether the wheel 310 is in contact with the ground surface.

Meanwhile, the leg part 200 may have a stopper 240. The stopper 240 may be disposed in the main body housing 110. The stopper 240 may be disposed adjacent to a rotary coupling part 410 of the arm 400. For example, the stopper 240 may be disposed in an inner peripheral surface of the rotary coupling part 410 formed in a cylindrical shape.

For example, the stopper 240 may be disposed on the leg support part (not illustrated). In another example, the stopper 240 may be disposed on the first link 210.

The stopper 240 may be formed in a shape protruding toward the rotary coupling part 410. For example, the stopper 240 may have a predetermined thickness and protrude in an arcuate (arch) shape disposed on a concentric circle. In this case, an outer peripheral surface of the stopper 240 may be disposed toward a front upper side of the robot 1, and an inner peripheral surface of the stopper 240 may be disposed toward a rear lower side of the stopper.

The stopper 240 may be in contact with and supported by a rotation protrusion 480 of the arm 400 to be described below. For example, the rotation protrusion 480, which protrudes from an inner peripheral surface of the rotary coupling part 410, may rotate in conjunction with the rotation of the arm 400. The arm 400 may come into contact with the rotation protrusion 480 in case that the arm 400 rotates to a predetermined position.

With this configuration, in case that the arm 400 rotates, the stopper 240 may restrict a rotation angle of the arm 400.

The entire balance implemented by the leg part 200 will be described. The first link 210 and the second link 220 are rotatably coupled to the link frame (not illustrated) provided in the robot main body 100, and the first link 210 and the second link 220 are linked to the third link 230. That is, the robot 1 has the structure in which the robot main body 100 is supported by a four-joint link including the link frame (not illustrated), the first link 210, the second link 220, and the third link 230.

Further, the leg part 200 generates a restoring force in a direction in which the gravity compensation part raises the robot main body 100. Therefore, even in a state in which the suspension motor MS does not operate, a state in which the pair of leg parts 200 raise the robot main body 100 by a predetermined height from the ground surface may be maintained.

Meanwhile, the robot 1 according to the embodiment of the present disclosure may maintain the balance by operating the suspension motor MS when the robot 1 raises any one of the pair of wheels 310 to climb over an obstacle or decreases the height of the robot main body 100 to charge the robot 1.

When the suspension motor MS operates, the first link 210 rotates about one end of the first link 210 adjacent to the suspension motor MS, and the other end of the first link 210 moves upward. Further, the third link 230 connected to the other end of the first link 210 is moved by the rotation of the first link 210. Further, the second link 220 rotates by being pushed by the third link 230. As a result, one end of the third link 230 (the point coupled to the first link 210) may move rearward, and the other end of the third link 230 may move upward.

With this configuration, a forward/rearward movement range of the wheel 310 may be restricted even though the wheel 310 moves in the vertical direction. Therefore, the robot 1 may stably maintain the balance.

Therefore, according to the present disclosure, the robot 1 may climbs over obstacles with various heights by using the four-joint link structure.

### Wheel Part

The wheel part 300 of the robot 1 according to the embodiment of the present disclosure will be described with reference to FIGS. 1 to 8.

The wheel part 300 may be rotatably coupled to the leg part 200 and configured to roll on the ground surface to move the robot main body 100 and the leg part 200. The robot 1 may be freely moved in a house by the rotations of the wheel parts 300.

The wheel part 300 includes the wheel 310 configured to come into contact with the ground surface and roll on the ground surface.

The wheel 310 is provided to have a predetermined radius and provided to have a predetermined width in an axial direction. When the robot 1 is viewed from the front side, at least a part of the robot main body 100 and the leg part 200 may be disposed vertically above the wheel 310.

Although not illustrated, the wheel 310 may include a wheel frame formed in a circular shape. The wheel frame may be formed in a cylindrical shape having one side that is directed toward the shaft of the wheel motor MW and opened. Therefore, it is possible to reduce a weight of the wheel frame.

However, when the wheel frame is formed in a cylindrical shape, the overall rigidity of the wheel frame may deteriorate. In consideration of the situation, ribs (not illustrated) for enhancing the rigidity may be formed on inner and outer surfaces of the wheel frame.

A tire is coupled to an outer peripheral surface of the wheel frame. The tire may be formed in an annular shape having a diameter so that the tire may be fitted with the outer peripheral surface of the wheel frame.

Grooves having predetermined patterns may be recessed in an outer peripheral surface of the tire to improve a ground contact force of the tire.

In the embodiment, the tire may be made of a rubber material having elasticity.

The wheel motor MW may provide driving power to the wheel 310. The wheel motor MW may generate a rotational force by receiving electric power from the battery 800.

The wheel motor MW may be accommodated in the third link 230 at the other side of the third link 230. Further, the shaft of the wheel motor MW may be coupled to the wheel 310. That is, the wheel motor MW may be an in-wheel motor.

With this configuration, when the wheel motors MW operate, the wheels 310 may roll along the ground surface while rotating, and the robot 1 may move along the ground surface.

### Arm

The arm 400 of the robot 1 according to the embodiment of the present disclosure will be described with reference to FIGS. 1 to 8.

The arm 400 may be pivotably coupled to two opposite surfaces of the robot main body 100. For example, the arm 400 may refer to a rotary body coupled to two opposite ends based on an axial direction (longitudinal direction) of the robot main body 100 with an ellipsoid shape and configured to rotate about a rotation axis defined by the two opposite ends of the robot main body 100 based on the axial direction.

Specifically, the arm 400 includes the rotary coupling parts 410, a connection part 420, an attaching/detaching part 430, and a connection terminal 440.

The rotary coupling parts 410 are rotatably coupled to the two opposite surfaces of the robot main body 100. The pair of rotary coupling parts 410 may be coupled to the two opposite sides of the robot main body 100 based on a leftward/rightward direction and configured to be relatively rotatable. In this case, the pair of rotary coupling parts 410 may rotate in conjunction with each other. That is, the pair of rotary coupling parts 410 may rotate simultaneously and have the same magnitude of the rotation angle. However, when viewed based on the robot main body 100, the rotation directions of the pair of rotary coupling parts 410 may be opposite to each other. That is, the rotary coupling part 410 at the other side may rotate counterclockwise when the rotary coupling part 410 at one side rotates clockwise when viewed based on the robot main body 100.

The rotary coupling part 410 may be shaped to cover the two opposite ends of the robot main body 100 based on the leftward/rightward direction. For example, the rotary coupling part 410 may be formed in a cylindrical shape having a predetermined thickness. In this case, the two opposite ends of the robot main body 100 based on the leftward/rightward direction may be disposed to face rotation centers of the rotary coupling parts 410.

That is, a state in which the rotary coupling part 410 is coupled to the robot main body 100 will be described. Assuming that the robot main body 100 is a human face, the rotary coupling parts 410 may be similar in shapes to a pair of earplugs or earpieces of a headset.

As illustrated in FIG. 4, an arm motor MA of the robot 1 according to the embodiment may be disposed in the main body housing 110. On the contrary, according to the embodiment, the arm motor MA may be disposed in the rotary coupling part.

The arm motor MA may be connected to the arm 400 and provide driving power to the arm 400. More specifically, a final output end of the shaft or gear of the arm motor MA is connected to the rotary coupling part 410. For example, as illustrated in FIG. 4, the shaft of the arm motor MA may be connected to a speed reducer 460, and the speed reducer 460 may be connected to a driven gear 470.

The speed reducer 460 may include at least one gear, transmit the rotational force, which is applied from the arm motor MA, to the driven gear 470, and reduce a rotational speed of the driven gear 470 by means of a gear ratio. Therefore, the precise rotation of the arm 400 may be controlled, and the arm 400 may provide a relatively high force.

The driven gear 470 may be coupled to the rotary coupling part 410 and rotate integrally. The driven gear 470 may engage with an output end of the speed reducer 460 and receive rotational power of the arm motor MA.

With this configuration, when the arm motor MA operates, the rotary coupling part 410 may rotate.

The arm motor MA may be provided as two arm motors MA respectively connected to the pair of rotary coupling parts 410. In another example, the arm motor MA may be provided as a single arm motor MA connected to any one of the rotary coupling parts 410.

With this configuration, when the arm motor MA operates, the pair of rotary coupling parts 410 rotate together in conjunction with each other, and the connection part 420 is also rotated in accordance with the rotations of the rotary coupling parts 410. That is, according to the present disclosure, the rotary coupling parts 410 and the connection part 420 of the arm 400 may integrally rotate about arm shafts of the rotary coupling parts 410 that define the rotation axis.

Meanwhile, speakers 450 may be disposed at outer sides of the rotary coupling parts 410. That is, the speakers 450 may be disposed on the pair of rotary coupling parts 410 in a direction opposite to a direction in which the robot main body 100 is disposed. Therefore, the speakers 450 may be respectively disposed at positions at which the two opposite sides of the main body housing 110 based on the leftward/rightward direction are covered.

The speaker 450 may transmit information on the robot 1 as a sound. A source of the sound transmitted by the speaker 450 may be sound data pre-stored in the robot 1. For example, the pre-stored sound data may be voice data of the robot 1. For example, the pre-stored sound data may be a notification sound that informs a state of the robot 1. Meanwhile, a source of the sound transmitted by the speaker 450 may be sound data received through the communication part 710.

Meanwhile, similar to human arms, a robot in the related art may have a pair of arms at two opposite sides of a main body and carry objects or perform particular tasks.

In contrast, in case that the pair of arms are provided as described above, the arms may move separately, and thus loads applied to the two opposite sides of the robot may vary. For this reason, there may occur a problem in that the robot tilts toward one side and falls over.

In addition, in a state in which the robot falls down, the arms may try to stand up while touching the ground surface. However, because the arms at the two opposite sides rotate separately and touch the ground surface, there is a limitation in that the robot may fall down again while losing balance during the process in which the robot stands up.

Meanwhile, in the case of a robot configured to carry objects or perform particular tasks by using one arm, there is a limitation in that a load of the object, which is carried by the robot, or an impact, which may occur while the tasks are performed, is concentrated only on one arm, which may damage the arm.

In order to cope with the limitations, the robot 1 according to the embodiment of the present disclosure is configured in a shape in which the single arm 400 is rotatably coupled to the two opposite sides of the robot main body 100.

The connection part 420 may connect the pair of rotary coupling parts 410. The connection part 420 may connect the pair of rotary coupling parts 410 configured to cover the two opposite sides of the robot main body 100 based on the leftward/rightward direction so that the pair of rotary coupling parts 410 rotate together.

The connection part 420 may be shaped to connect the pair of rotary coupling parts 410 and rotate about the robot main body 100. Specifically, the connection part 420 may be formed in a frame shape having two opposite longitudinal ends that are bent and extend. In this case, the two opposite ends of the connection part 420, which are bent and extend, may be disposed side by side and connected to the pair of rotary coupling parts 410. For example, the connection part 420 may be formed in a ‘∩’ shape. In another example, the connection part 420 may be formed in an arcuate shape.

The state in which the arm 400 is coupled to the robot main body 100 will be described. Assuming that the robot main body 100 is a human face, the connection part 420 may have a shape similar to a hair band of a headphone. That is, assuming that the robot main body 100 is a human face, the arm 400 may be similar in shape to a headset.

The connection part 420 may be integrated with the pair of rotary coupling parts 410. That is, the pair of rotary coupling parts 410, which are respectively disposed at the left and right sides of the robot main body 100, and the connection part 420 may constitute the arm 400 having the integrated structure.

With this configuration, the pair of rotary coupling parts 410 may be integrally connected to the connection part 420, and the entire arm 400 may rotate about the rotary coupling part 410 as a rotation center.

Meanwhile, a rotation radius of the arm 400 may be longer than a maximum length of the first link 210 and shorter than a maximum length of the leg part 200. Specifically, a shortest distance from the rotation center of the rotary coupling part 410 to an outer end of the connection part 420 may be longer than the maximum length of the first link 210 and shorter than the maximum length of the leg part 200.

With this configuration, when the arm 400 rotates, at least a part of the arm 400 may be disposed to be closer to the ground surface than the first link 210 to the ground surface.

Meanwhile, the arm 400 further includes the rotation protrusion 480 protruding from the inner peripheral surface of the rotary coupling part 410.

The rotation protrusion 480 may protrude from the inner peripheral surface of the rotary coupling part 410 and be formed in a shape having a circumferential width that decreases in a direction from the inner peripheral surface of the rotary coupling part 410 toward the rotation center of the rotary coupling part 410 (see FIG. 4).

The rotation protrusion 480 may rotate together with the rotary coupling part 410 and the connection part 420. That is, in case that the rotary coupling part 410 and the connection part 420 are rotated, the rotation protrusion 480 rotates at the same rotation angle as the rotary coupling part 410 and the connection part 420.

The rotation protrusion 480 may be brought into contact with and supported by the stopper 240 as the arm 400 rotates. For example, in case that the connection part 420 passes over a rear side of the robot main body 100 and rotates to be closer to the ground surface than the first link 210 to the ground surface, the rotation protrusion 480 may come into contact with the stopper 240.

With this configuration, in case that the arm 400 rotates to a predetermined position, the stopper 240 and the rotation protrusion 480 may be brought into contact with and supported by each other, thereby restricting a rotation of the arm 400.

In addition, it is possible to maintain postures of the arm 400 and the leg part 200 while maintaining the state in which the stopper 240 and the rotation protrusion 480 support each other.

Meanwhile, FIGS. 6 and 7 are views for explaining another embodiment of the arm of the disclosure robot according to the present.

An arm 1400 according to another embodiment of the present disclosure will be described below with reference to FIGS. 6 and 7.

To avoid the repeated description, the description of the arm 400 according to the embodiment of the present disclosure may be applied, except for the components that have not been particularly described in the present embodiment, because the same structure and effect of the arm 400 may be applied.

The arm 1400 of the present embodiment further includes a terminal rotation part 1460, and a switching motor MC configured to provide a rotational force to the terminal rotation part 1460.

The terminal rotation part 1460 is rotatably coupled to a connection part 1420. For example, the terminal rotation part 1460 may be provided in the form of a plate having a predetermined thickness, and an attaching/detaching part 1430 and a connection terminal 1440 may be disposed on one surface of the terminal rotation part 1460.

The terminal rotation part 1460, together with the connection part 1420, may define an external appearance of the arm 1400. Rotary shafts may be provided at two opposite longitudinal ends of the terminal rotation part 1460 and coupled to the connection part 1420.

The switching motor MC may be connected to the terminal rotation part 1460 and provide rotational force to the terminal rotation part 1460. More specifically, a final output terminal of a shaft or gear of the switching motor MC is connected to the terminal rotation part 1460.

With this configuration, when the switching motor MC operates, the terminal rotation part 1460 rotates.

When the terminal rotation part 1460 rotates, a surface of the terminal rotation part 1460 exposed to the outside may be switched. Specifically, one surface of the terminal rotation part 1460, outside which the attaching/detaching part 1430 and the connection terminal 1440 are disposed, may be exposed to the outside. Further, when the terminal rotation part 1460 rotates, the attaching/detaching part 1430 and the connection terminal 1440 may be hidden in an internal space of the connection part 1420.

With this configuration, in case that the arm 1400 and the function module do not need to be coupled, the attaching/detaching part 1430 and the connection terminal 1440 may be hidden in the connection part 1420.

In particular, in case that the robot 1 falls down, the arm 1400 needs to rotate to allow the connection part 1420 to touch the ground surface. In this case, the attaching/detaching part 1430 and the connection terminal 1440 may be sometimes contaminated or damaged while coming into contact with the ground surface.

Therefore, according to the arm 1400 of the present embodiment, the terminal rotation part 1460 may rotate to prevent the attaching/detaching part 1430 and the connection terminal 1440 from being exposed to the outside. Further, it is possible to prevent the attaching/detaching part 1430 and the connection terminal 1440 from being contaminated or damaged.

### Robot Mask

FIG. 9 is a view for explaining a coupling relationship between the robot mask and the robot main body of the robot according to the embodiment of the present disclosure.

The robot 1 according to the embodiment of the present disclosure may further include the robot mask 500.

The robot mask 500 may be detachably coupled to the robot main body 100 and cover the display 120. The robot mask 500 may be coupled to the robot main body 100 and constitute an external appearance of the robot 1.

Meanwhile, the robot mask 500 according to the embodiment of the present disclosure may include a window 550 through which an image displayed by the display 120 is exposed to the outside when the window 550 is coupled to the robot main body 100.

The window 550 may be disposed on a mask main body 510. Specifically, the window 550 may be disposed while penetrating the mask main body 510. In case that the robot mask 500 is coupled to the robot main body 100, the window 550 may be disposed at a position facing the display 120.

The window 550 may be made of a material that may transmit light. For example, the window 550 may be made of a transparent material.

Meanwhile, when the robot mask 500 is coupled to the robot main body 100, the display 120 may display a face and a facial expression.

The robot 1 may display the shape of the face, such as the eyes, nose, and mouth, on the display 120 to allow the user to feel that the robot expresses emotions.

In this way, the robot 1 may provide a pet robot service that shows emotions to the user and communicates with the user, and the robot 1 may have the effect of providing emotional stability to the user.

As described above, the robot 1 may display facial expressions on the display 120 to visually display emotions, and the robot 1 may also display emotions through a voice output of the speaker 450.

For example, it is possible to output sounds of laughter, surprise, and the like in response to facial expressions displayed on the display 120.

In addition, the robot 1 may display facial expressions on the display 120 to visually display emotions, and the robot 1 may also display emotions by rotating the arm 400.

For example, the robot may display a smiling facial expression on the display 120 and display emotions by shaking the arm 400.

### Control Configuration

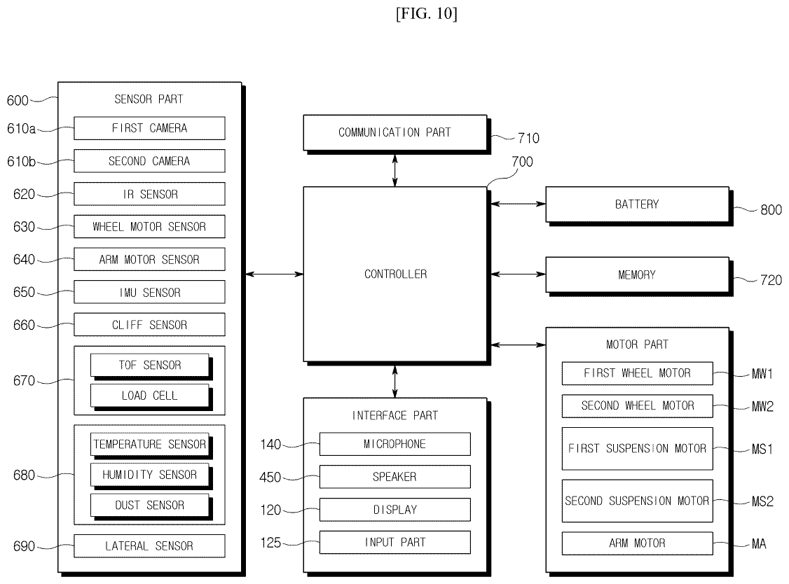

FIG. 10 is a block diagram for explaining a control configuration of the robot according to the embodiment of the present disclosure.

With reference to FIG. 10, the robot 1 according to the embodiment of the present disclosure may include a sensor part 600, the controller 700, the communication part 710, a memory 720, the battery 800, a motor part, and an interface part.

The constituent elements illustrated in the block diagram in FIG. 10 are not essential to implement the robot 1. The robot 1, which is described in the present specification, may have constituent elements larger or smaller in number than the constituent elements listed above.

First, the controller 700 may control an overall operation of the robot 1. The controller 700 may perform control to allow the robot 1 to perform various functions based on setting information stored in the memory 720 to be described below.

The controller 700 may be disposed on the robot main body 100. More specifically, the controller 700 may be mounted and provided on a PCB disposed in the main body housing 110.

The controller 700 may include any type of device capable of processing data, such as a processor. Here, the ‘processor’ may refer to a data processing device embedded in hardware and having, for example, a circuit physically structured to perform a function represented by codes or instructions included in a program. Examples of the data processing device embedded in hardware may include processing devices such as a microprocessor, a central processing unit (CPU), a processor core, a multiprocessor, an application-specific integrated circuit (ASIC), or a field programmable gate array (FPGA), but the scope of the present disclosure is not limited thereto.

The controller 700 may receive information on an external environment of the robot 1 from at least one of the components of the sensor part 600 to be described below. In this case, for example, the information on the external environment may be information on a temperature, a humidity, the amount of dust, and the like in the interior in which the robot 1 travels. Alternatively, for example, the information may be information on a cliff. Alternatively, for example, the information may be information on an interior map. Of course, the information on the external environment is not limited to the above-mentioned examples.

The controller 700 may receive information on a current state of the robot 1 from at least one of the components of the sensor part 600 to be described below. In this case, for example, the current state may be information on a gradient of the robot main body 100. Alternatively, for example, the information may be information on a spaced state between the wheel 310 and the ground surface. Alternatively, for example, the information may be information on a position of the wheel motor MW. Alternatively, for example, the information may be information on a position of the suspension motor MS. Of course, the information on the current state of the robot 1 is not limited to the above-mentioned example.

The controller 700 may transmit a driving control instruction to at least one of the components of the motor part to be described below. The controller 700 may control the rotation of one or more of the wheel motor MW, the suspension motor MS, and the arm motor MA in order to implement any one of the operation of driving the robot 1, maintaining the posture of the robot 1, and switching the posture of the robot 1.

The controller 700 may receive the user's instruction through at least one of the components of the interface part to be described below. For example, the instruction may be an instruction for turning on or off the robot 1. Alternatively, for example, the instruction may be an instruction for manually controlling various types of functions of the robot 1.

The controller 700 may output the information on the robot 1 through at least one of the components of the interface part to be described below. For example, the outputted information may be visual information. Alternatively, for example, the outputted information may be auditory information.

The motor part may include at least one motor and provide driving power to components connected to the motor.

The motor part may include the wheel motors MW configured to provide driving power to the left and right wheels 310. More specifically, the motor part may include a first wheel motor MW1 configured to transmit driving power to the wheel 310 disposed at one side based on the leftward/rightward direction, and a second wheel motor MW2 configured to transmit driving power to the wheel 310 disposed at the other side based on the leftward/rightward direction.

The wheel motors MW may be respectively disposed in the wheel parts 300. More specifically, the wheel motor MW may be accommodated in the third link 230.

The wheel motor MW is connected to the wheel 310. More specifically, a final output end of a shaft or gear of the first wheel motor MW1 is connected to the wheel 310 disposed at one side based on the leftward/rightward direction. A final output end of a shaft or gear of the second wheel motor MW2 is connected to the wheel 310 disposed at the other side based on the leftward/rightward direction. The wheel motors MW at the left and right sides rotate by being operated in response to the control instruction of the controller 700, and the robot 1 travels along the ground surface by the rotations of the wheels 310 performed by the rotations of the wheel motors MW.

The motor part may include the suspension motors MS configured to provide driving power to the left and right leg parts 200. More specifically, the motor part may include a first suspension motor MS1 configured to transmit driving power to the leg part 200 disposed at one side based on the leftward/rightward direction, and a second suspension motor MS2 configured to transmit driving power to the leg part 200 disposed at the other side based on the leftward/rightward direction.

The suspension motor MS may be disposed on the robot main body 100. More specifically, the suspension motors MS may be accommodated in the main body housing 110.

The suspension motor MS is connected to the first link 210. More specifically, the final output end of the shaft or gear of the first suspension motor MS1 is connected to the first link 210 disposed at one side based on the leftward/rightward direction. The final output end of the shaft or gear of the second suspension motor MS2 is connected to the first link 210 disposed at the other side based on the leftward/rightward direction. The suspension motors MS at the left and right sides may rotate by being operated in response to the control instruction of the controller 700. As the suspension motor MS rotates, the first link 210 rotates, and the third link 230 connected to the first link 210 rotates, and as a result, an angle between the first link 210 and the third link 230 may be changed.

Therefore, the robot 1 may operate to raise or lower the wheels 310, thereby maintaining the horizontal posture when the robot 1 climbs over an obstacle or travels along a curved ground surface. Alternatively, the downward movement or upward movement of the robot main body 100 may be performed.

The motor part may include the arm motor MA configured to provide a rotational force to the arm 400.

The arm motor MA may be disposed on the robot main body 100. More specifically, at least one arm motor MA may be accommodated in the main body housing 110.

The arm motor MA may rotate by being operated in response to the control instruction of the controller 700. As the arm motor MA rotates, the rotary coupling part 410 rotates, the connection part 420 integrated with the rotary coupling part 410 rotates, and as a result, the arm 400 may pivot relative to the robot main body 100.

Therefore, the robot 1 may rotate the arm 400 and be coupled to the functional module by rotating the arm 400. Alternatively, when the arm 400 rotates, the arm 400 may touch the ground surface.

The sensor part 600 may include at least one sensor, and the sensor may measure or detect the information on the external environment of the robot 1 and/or the information on the current state of the robot 1.

The sensor part 600 may include the first camera 610a.

The first camera 610a is provided to map the interior in which the robot 1 travels. The first camera 610a may be referred to as a mapping camera 610a.

To this end, the first camera 610a may be disposed at the front side of the robot main body 100. More specifically, the first camera 610a may be disposed forward of the main body housing 110.

The first camera 610a may capture images of the interior to perform simultaneous localization and mapping (SLAM). The controller 700 may implement the SLAM on the basis of information on a surrounding environment captured by the first camera 610a and information on a current location of the robot 1.

Meanwhile, the method of implementing the SLAM by the robot 1 according to the embodiment of the present disclosure may be a method implemented only by the first camera 610a. However, the present disclosure is not limited thereto. For example, the robot 1 may also implement the SLAM by further utilizing a sensor additionally provided. For example, the additional sensor may be a laser distance sensor (LDS). Alternatively, for example, the additional sensor may be light detection and ranging (LiDAR).

The sensor part 600 may include a second camera 610b.

The second camera 610b is a component provided to recognize a location, a distance, a height, or the like of an object (an item, a human body, or the like) present at a front side based on a traveling direction. The second camera 610b may be referred to as a depth camera.

The second camera 610b may be disposed at the front side of the robot main body 100 to detect an object present forward of the robot main body 100 when the robot 1 travels forward. The second camera 610b may be additionally disposed at the rear side of the robot main body 100 to detect an object present rearward of the robot main body 100 when the robot 1 travels rearward.

The second camera 610b may recognize a location of an object by capturing an image of the front side (the front side during the forward movement or the rear side during the rearward movement) based on the direction in which the robot 1 travels. To this end, the second camera 610b may have a depth module and an RGB module.

The depth module may acquire depth information of an image. For example, the depth information may be acquired by acquiring movement time information by measuring a delay of a modulated optical signal or a phase shift for all pixels of the captured image.

The RGB module may acquire color images. Boundary characteristics (edge), color distribution, frequency characteristics (or wavelet transform), and the like may be extracted from the color image.

As described above, distance and/or height information for a recognition target object may be acquired on the basis of depth information of an image of the front side captured by the second camera 610b, and whether an object is present at the front side and/or a location of the object may be recognized by calculating the boundary characteristics extracted from the color image.

The sensor part 600 may include the IR sensors 620 configured to detect infrared rays.

The IR sensor 620 may be an IR camera configured to detect infrared rays.

The IR sensor 620 may be disposed on the robot main body 100. More specifically, the IR sensor 620 may be disposed at the front side of the main body housing 110. The IR sensors 620 may be disposed at the left and right sides of the first camera 610a.

The IR sensor 620 may detect infrared rays emitted from an IR LED provided on a particular module and approach the module. For example, the module may be a charging stand configured to charge the robot 1. For example, the module may be the functional module provided to be detachable from the arm 400.

In case that a state of charge of the robot 1 is a preset level or lower, the controller 700 may perform control to allow the IR sensor 620 to begin to detect the IR LED. In case that the controller 700 receives an instruction to search for a particular module from the user, the controller 700 may perform control to allow the IR sensor 620 to begin to detect the IR LED.

The sensor part 600 may include a wheel motor sensor 630.

The wheel motor sensor 630 may measure a position of the wheel motor MW. For example, the wheel motor sensor 630 may be an encoder. As well known, the encoder may detect a position of the motor and further detect a rotational speed of the motor.

The wheel motor sensor 630 may be disposed in each of the left and right wheel motors MW. More specifically, the wheel motor sensor 630 may be connected to the final output end of the shaft or gear of the wheel motor MW and accommodated in the third link 230 together with the wheel motor MW.

The sensor part 600 may include an arm motor sensor 640.

The arm motor sensor 640 may measure a position of the arm motor MA. For example, the arm motor sensor 640 may be an encoder. As well known, the encoder may detect a position of the motor and further detect a rotational speed of the motor.

The arm motor sensor 640 may be disposed in the arm motor MA. More specifically, the arm motor sensor 640 may be connected to the final output end of the shaft or gear of the arm motor MA and accommodated in the main body housing 110 or the rotary coupling part 410 together with the arm motor MA.

The sensor part 600 may include an IMU sensor 650.

The IMU sensor 650 may measure an inclination angle of the robot main body 100.

As well known, the IMU (inertial measurement unit) sensor 650 is a sensor embedded with a three-axis acceleration sensor, a three-axis gyro sensor, and a terrestrial magnetism sensor and also called an inertia measurement sensor.

The three-axis acceleration sensor is a sensor configured to detect a gravitational acceleration of an object in a stationary state. Because the gravitational acceleration varies depending on an angle at which an object is inclined, a gradient angle is obtained by measuring the gravitational acceleration. However, there is a disadvantage in that a correct value cannot be obtained in an accelerated state instead of a stationary state.

The three-axis gyro sensor is a sensor configured to measure an angular velocity. The gradient angle is obtained by integrating the angular velocity over the overall time. However, the angular velocity measured by the gyro sensor has continuous errors caused by noise and the like. These errors cause errors in the integral value that accumulate and occur over time.

As a result, when the robot 1 is in the stationary state for a long time, the gradient may be accurately measured by the acceleration sensor, but an error occurs by the gyro sensor. When the robot 1 travels, the gyro sensor may measure the correct gradient value, but the acceleration sensor cannot obtain the correct value.

The IMU sensor may be used to compensate for the above-mentioned drawbacks of the acceleration sensor and the gyro sensor.

In the present specification, the embodiment in which the IMU sensor is provided will be described.

The IMU sensor may be disposed on the robot main body 100. More specifically, the IMU sensor may be disposed adjacent to the controller 700. The IMU sensor may be mounted and provided on a PCB disposed in the robot main body 100. The IMU sensor may be disposed to be close to a central region of the robot main body 100 in order to improve the accuracy in measuring the inclination angle and the direction.

The IMU sensor may measure at least one of a three-axis acceleration, a three-axis angular velocity, and three-axis terrestrial magnetism data of the robot main body 100 and transmit at least one of the three-axis acceleration, the three-axis angular velocity, and the three-axis terrestrial magnetism data to the controller 700.

The controller 700 may calculate an inclination direction and an inclination angle of the robot main body 100 by using at least one of the acceleration, the angular velocity, and the terrestrial magnetism data received from the IMU sensor. The controller 700 may maintain and control the horizontal posture of the robot main body 100 to be described below on the basis of the inclination direction and the inclination angle.

The sensor part 600 may include a cliff sensor 660 configured to detect a cliff.

The cliff sensor 660 may be configured to detect a distance from the front ground surface on which the robot 1 travels. The cliff sensor 660 may be variously configured within a range in which the cliff sensor 660 may detect a relative distance between the ground surface and a point at which the cliff sensor 660 is provided.

For example, the cliff sensor 660 may include a light-emitting part configured to emit light, and a light-receiving part configured to receive reflected light. The cliff sensor 660 may be configured as an infrared sensor.

The cliff sensor 660 may be disposed on the robot main body 100. More specifically, the cliff sensor 660 may be disposed inside the robot main body 100. The cliff sensor 660 may emit light toward a floor surface disposed forward of the robot 1. The cliff sensor 660 may detect in advance whether a cliff exists in front of the robot 1 in the traveling direction.

The light-emitting part of the cliff sensor 660 may emit light obliquely toward the front floor surface. The light-receiving part of the cliff sensor 660 may receive the incident light reflected by the floor surface. A distance between the front ground surface and the cliff sensor 660 may be measured on the basis of a difference between a light emitting time point and a light receiving time point.

A case in which the distance measured by the cliff sensor 660 exceeds a preset predetermined value or exceeds a predetermined range may be a case in which the front ground surface is suddenly lowered. A cliff may be detected on the basis of this principle.

In case that a front cliff is detected, the controller 700 may control the wheel motors MW so that the robot 1 travels while avoiding the detected cliff. In this case, the control of the wheel motor MW may be the stop control. Alternatively, the control of the wheel motor MW may be the control for switching the rotation direction.

The sensor part 600 may include a contact detection sensor 670.

The contact detection sensor 670 may detect whether the wheel 310 comes into contact with the ground surface.

The contact detection sensor 670 may include a TOF sensor configured to measure a spacing distance between the wheel 310 of the robot 1 and the ground surface. The TOF sensor may be a three-dimensional camera to which a time-of-flight (TOF) technology is applied. As well known, the TOF technology refers to a technology for measuring a distance from an object on the basis of the round-trip flight time for which the light is emitted toward the object and reflected back.

The TOF sensor may be disposed in the wheel part 300. For example, the contact detection sensor 670 may be disposed on each of the left and right third links 230. It is possible to determine whether the wheel 310 is in a state of being in contact with the ground surface on the basis of the distance from the ground surface measured by the TOF sensor. In case that the distance measured by the TOF sensor is less than a preset distance (or less than a lower limit value of a preset distance range), the wheel 310 is in a state of being in contact with the ground surface. In case that the distance measured by the TOF sensor is a preset distance or more (or an upper limit value or more of the preset distance range), the wheel 310 is in a state of being spaced apart from the ground surface.

The contact detection sensor 670 may include a load cell configured to measure a magnitude of a force applied to some components of the robot 1.

As well known, when a force is applied to the load cell, a resistance value of a strain gauge provided on a surface of the load cell changes. In this case, it is possible to measure a magnitude of the force applied to the load cell on the basis of the change in resistance value.

The load cell may be disposed on the leg part 200. Particularly, the load cell may be disposed on each of the left and right third links 230. The third link 230 is transformed as a vertical drag force is applied to the third link 230 from the ground surface in the state in which the wheel 310 is in contact with the floor. The measurement value of the load cell is a value different from an initial value as the third link 230 is transformed. Therefore, it is possible to determine whether the wheel 310 is in a state of being in contact with the ground surface.

The sensor part 600 may include an environmental sensor 680.

The environmental sensor 680 may be configured to measure various environmental states of the outside of the robot 1, i.e., various environmental states in the house in which the robot 1 travels. The environmental sensor 680 may include at least one of a temperature sensor, a humidity sensor, and a dust sensor.

The environmental sensor 680 may be disposed on the robot main body 100. More specifically, the environmental sensor 680 may be disposed at the rear side of the robot main body 100. In a possible embodiment, the information measured by the environmental sensor 680 may be visually displayed on the display 120.

The sensor part 600 may include a lateral sensor 690.

The lateral sensor 690 may measure a distance from an obstacle including a wall surface or the like.

The lateral sensor 690 may be configured to detect a distance from a wall surface of a lateral surface on which the robot 1 travels. The lateral sensor 690 may be variously configured within a range in which the lateral sensor 690 may detect a relative distance between an obstacle and a point at which the lateral sensor 690 is disposed.

For example, the lateral sensor 690 may include a light-emitting part configured to emit light, and a light-receiving part configured to receive reflected light. The lateral sensor 690 may be configured as an infrared sensor.

The lateral sensors 690 may be disposed on two opposite surfaces of the robot 1. For example, the lateral sensor 690 may be disposed on an outer surface of the third link 230 of the leg part 200.

The interface part may include at least one component for implementing an interaction between the user and the robot 1, and the component may be configured to input an instruction from the user and/or output information to the user.

The interface part may include a microphone 140.

The microphone 140 may be configured to recognize the user's voice and provided as a plurality of microphones 140. The plurality of microphones 140 may be disposed in the main body housing 110. For example, four microphones 140 may be disposed at the upper side of the main body housing 110.

A voice signal received by the microphone 140 may be used to track the user's position. In this case, a publicly-known sound source tracking algorithm may be applied. For example, the sound source tracking algorithm may be a three-point measurement method (triangular measurement method) using a difference between times at which the plurality of microphones 140 receive the voice signals. The principle is that the position of the voice source is calculated by using the position of the microphone 140 and the speed of the sound waves.

Meanwhile, when the microphone 140 and the above-mentioned first camera 610a cooperate with each other, the cooperation may be implemented so that the robot 1 finds the user's position even in case that the user calls the robot 1 from a remote location.

The interface part may include the speaker 450.

The speaker 450 may be disposed on the arm 400. For example, the speaker 450 may be disposed on the rotary coupling part 410 of the arm 400. The speakers 450 may be respectively disposed at positions at which the two opposite sides of the main body housing 110 based on the leftward/rightward direction are covered.

The speaker 450 may transmit information on the robot 1 as a sound. A source of the sound transmitted by the speaker 450 may be sound data pre-stored in the robot 1. For example, the pre-stored sound data may be voice data of the robot 1. For example, the pre-stored sound data may be a notification sound that informs a state of the robot 1. Meanwhile, a source of the sound transmitted by the speaker 450 may be sound data received through the communication part 710.

The interface part may include the display 120 and the input part 125.

The display 120 may include displays disposed on one or more modules. The display 120 may be disposed at a front upper side of the robot main body 100.

The display 120 may include any one of a light-emitting diode (LED), a liquid crystal display (LCD), a plasma display panel, and an organic light-emitting diode (OLED).

The display 120 may display information such as information on an operating time of the robot 1 and information on electric power of the battery 800.

The display 120 may display a facial expression of the robot 1. Alternatively, the display 120 may display pupils of the robot 1. A current state of the robot 1 may be expressed as an anthropomorphic emotion through a facial shape or a pupil shape displayed on the display 120. For example, when the user goes out and returns, a smiling face or smiling eyes may be displayed on the display 120. Therefore, the user has an effect of feeling in communion with the robot 1.

The input part 125 may be configured to receive a control instruction for controlling the robot 1 from the user. For example, the control instruction may be an instruction for changing various settings of the robot 1. For example, the settings may be voice volume, display brightness, and power saving mode settings.

The input part 125 may be disposed on the display 120.

The input part 125 generates key input data inputted by the user to control the operation of the robot 1. To this end, the input part 125 may include a keypad, a dome switch, a touchpad (resistive touchpad/capacitive touchpad), and the like. In particular, in case that the touchpad defines a mutual layer structure together with a first display, the touchpad may be called a touch screen.

The communication part 710 may be provided to transmit signals between the components in the robot 1. For example, the communication part 710 may support controller area network (CAN) communication. For example, the signal may be a control instruction to be transmitted from the controller 700 to other components.

The communication part 710 may support wireless communication with other devices existing outside the robot 1. As a wireless communication module for wireless communication support, a near-field communication module or a far-field communication module may be provided.

For example, a short-range communication may be Bluetooth communication, near field communication (NFC) communication, or the like.

For example, the far-field communication may be wireless LAN (WLAN), digital living network alliance (DLNA), wireless broadband (Wibro), world interoperability for microwave access (Wimax), global system for mobile communication (GSM), code division multi-access (CDMA), code division multi-access 2000 (CDMA 2000), enhanced voice-data optimized or enhanced voice-data only (EV-DO), wideband CDMA (WCDMA), high-speed downlink packet access (HSDPA), high-speed uplink packet access (HSUPA), IEEE 802.16, long term evolution (LTE), long term evolution-advanced (LTEA), wireless mobile broadband service (WMBS), Bluetooth low energy (BLE), Zigbee, radio frequency (RF), long range LoRa, and the like.

The memory 720 is configured to store various data for operating or driving the robot 1.

The memory 720 may store application programs and various relevant data for allowing the robot 1 to autonomously travel. The memory 720 may also store data sensed by the sensor part 600 and store setting information on various settings selected or inputted by the user.

The memory 720 may include magnetic storage media or flash storage media. However, the scope of the present disclosure is not limited thereto. The memory 720 may include an internal memory and/or an external memory. The memory 720 may include a volatile memory such as a DRAM, an SRAM, or an SDRAM, a non-volatile memory such as a one-time programmable ROM (OTPROM), a PROM, an EPROM, an EEPROM, a mask ROM, a flash ROM, a NAND flash memory, or a NOR flash memory, a flash drive such as an SSD, a compact flash (CF) card, an SD card, a Micro-SD card, a Mini-SD card, an Xd card, or a memory stick, or a storage device such as an HDD.

The memory 720 may be included in the controller 700 or provided as a separate component.

The battery 800 is configured to supply electric power to other components constituting the robot 1.

The battery 800 may be disposed in the robot main body 100. More specifically, the battery 800 may be accommodated in the main body housing 110. Although not illustrated, the battery 800 may be disposed rearward of the suspension motor MS.

The battery 800 may be charged with external electric power. To this end, the charging terminal 130 for charging the battery 800 may be provided at one side of the robot main body 100. In the present disclosure embodiment, the charging terminal 130 may be disposed at the lower side of the robot main body 100. Therefore, the robot 1 may approach the charging stand and move downward, such that the robot 1 may be easily coupled to the charging stand in such a way that the charging terminal 130 is seated on the corresponding terminal of the charging stand from above.

### Registration of Traveling Map and User

A traveling map of the house may be registered in the memory 720 of the robot 1 according to the embodiment of the present disclosure.

The traveling map may be created when the robot 1 initially travels in the house. The creation of the traveling map may be implemented by a well-known SLAM algorithm.

The simultaneous localization and map-building (SLAM) algorithm is, as well known, an algorithm that creates a map of an external environment while simultaneously measuring and calculating a location of the robot in real time.

The first camera 610a may be used to sense the external environment in order to implement the SLAM algorithm. Alternatively, a laser distance sensor (LDS) may be further additionally used. The light detection and ranging (LiDAR) may also be used to sense the external environment. The first camera 610a, the LDS, the LiDAR, and the like may be provided on the robot main body 100.

The created traveling map has a plurality of distinguished regions.

When the robot 1 according to the embodiment of the present disclosure initially travels, the robot 1 may define the rooms, which are surrounded by walls, as independent regions while creating the traveling map.

The controller 700 of the robot 1 may analyze the captured image to identify and distinguish the purposes of the regions. However, the present disclosure is not limited thereto. For example, the controller 700 may distinguish between the regions based on doors. Alternatively, for example, the regions may be distinguished directly by the user.

The controller 700 may set designations for the distinguished regions. For example, the living room may be designated as room 1, the main bedroom may be designated as room 2, and the small bedrooms are designated as room 3 and room 4. The preset designations may be stored in the memory 720. The designations of the preset regions may be changed in order or modified to new designations by the user.

The memory 720 may store and register one or more users in advance.

In this case, the user's face and/or voice may be registered together with the user's name when the user is initially registered.

The sensor part 600 may detect the user located outside the robot main body 100. More specifically, the robot 1 may detect the user by means of the second camera 610b while traveling. The controller 700 may distinguish who is the currently detected user among the plurality of registered users by using the faces and/or voices registered in advance. Publicly-known facial recognition and/or voice recognition technologies may be used to distinguish between the users. Prior to the voice recognition, the robot 1 may ask preset particulars set in advance to prompt the user to speak.

In the embodiment of the present disclosure, the memory 720 may store a location probability indicating a likelihood of the user being located in each of the distinguished regions in the house.

In this case, the location probability for each of the regions of the plurality of users registered in advance may be stored.

The location probability refers to the probability that the user is detected in the corresponding region. The location probability may be expressed as the unit of a percentage (%). However, the present disclosure is not limited thereto. The location probability may be expressed as numerical values such as a minority or a fraction.

When the location probability is expressed as a percentage, a case in which user 1 has a location probability of 60 in room 1, a location probability of 30 in room 2, and a location probability of 10 in room 3 means that user 1 has a probability of 60% of being found (detected) in room 1, a probability of 30% of being found in room 2, and a probability of 10% of being found in room 3.

An initial value of the location probability may be set in advance for each of the users. For example, the user, who spends the most time in room 1 (living room), may set the location probability of the living room higher than the other regions.

The initial value of the location probability may be set to 0. The robot 1 may update the location probability by detecting or not detecting the user while traveling. That is, the location probability may be updated depending on whether the user is detected at the current location at which the robot 1 is traveling. In this case, the location probability may be updated by the controller 700.

### Searching for Target User

The instruction, which needs to be executed by the robot 1, may be related to the registered user.

For example, user 1 may give a beverage bottle to the robot 1 and instruct the robot 1 to deliver the beverage bottle to user 2. Alternatively, for example, user 2 may inquire about the current location of user 3 to the robot 1. Alternatively, for example, user 1 may instruct a message to be sent to user 3.

As described above, the target users related to various instructions, which need to be executed by the robot 1, are determined.

In the first and third examples, user 1, who receives an item, and user 2, who receives a message, are the target users. In the second example, user 3, whose current location needs to be recognized, is the target user.

The controller 700 may perform the instructions on the basis of the location probability currently stored for the target users.

In the first and third examples, the robot 1 may move toward the target user to deliver an item or send a message. In the second example, the robot 1 may inform user 2 of a region where there is the highest probability that the target user is currently located on the basis of the location probability of the target user.

The controller 700 may create a movement route for the robot 1 on the basis of the location probability of the target user in case that the robot 1 needs to move toward the target user (in the first and third examples. but the present disclosure is not limited thereto).

More specifically, in the embodiment of the present disclosure, the movement route may be created on the basis of the order of the location probability for the target users. That is, the movement route may be created so that the robot 1 visits the region with the highest location probability first and then visits the region with the lowest location probability last.

Therefore, according to the present disclosure, it is possible to quickly detect the target user in comparison with the case in which the robot moves to search for the target user each time the robot receives an instruction. This provides an effect of enabling the robot 1 to quickly perform the instruction, thereby improving the user's satisfaction. In addition, this also provides an effect of reducing the amount of consumption of the battery by shortening a traveling distance by which the robot 1 searches for the target user.

The controller 700 may update the location probability.

When the location probability is updated, a value made by adding up the location probabilities for the respective distinguished regions may be maintained as 100%.

The configuration has been described above in which the location probability may be updated depending on whether the registered user is detected in case that the initial value of the location probability is set to 0.

The description will be more specific as follows.

In case that the user is detected by the sensor part 600 in the current region in which the robot main body 100 is located, the controller 700 may update the location probability of the current region to 100% because it is certain that the detected user is present in the current region.

In this case, it is also certain that the user present in the current region is not present in any other region. That is, the controller 700 may update all the location probabilities of the remaining regions, which excludes the current region, to 0%.

For example, it is assumed that the robot 1 starts traveling in room 1 (living room). In case that the robot 1 detects registered user 1 in the living room, the location probability for user 1 in the living room may be updated to 100%, and the location probabilities of the other remaining regions may be maintained as 0%.

In case that the user is not detected by the sensor part 600 in the current region in which the robot main body 100 is located, the controller 700 may update the location probability of the current region to 0% because it is certain that the user, which is not detected, is not present in the current region.

It is assumed again that the robot 1 starts traveling in room 1 (living room). In case that the robot 1 cannot detect registered user 2 in the living room, the location probability for user 2 in the living room may be maintained as 0%, and the location probabilities of the other remaining regions may be increased.

When the user is not detected in the current region, i.e., when the controller 700 updates the location probability of the current region to 0%, the location probabilities of the remaining spaces excluding the current region may be updated so that the location probabilities increase by the same amount.

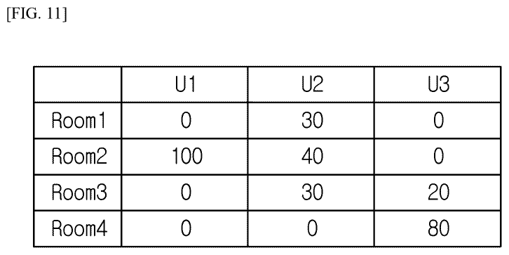

The update of the location probability will be described below with reference to FIGS. 11 to 13.

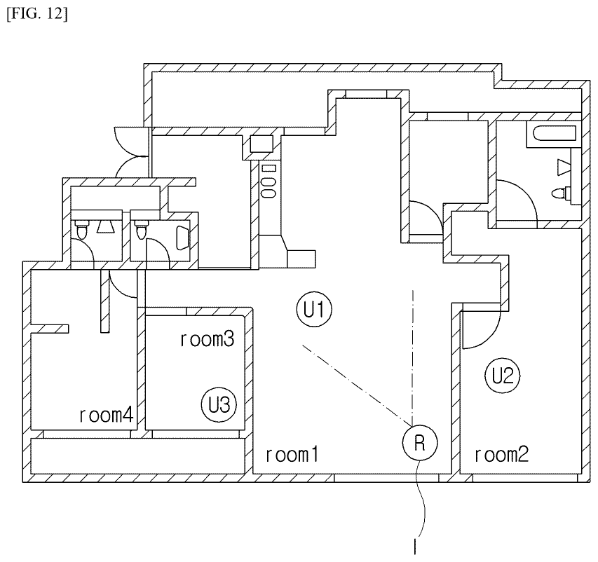

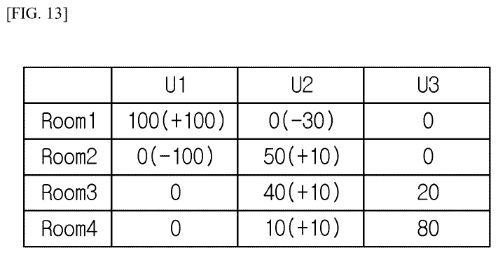

FIG. 11 is a view illustrating one example and illustrating location probabilities of user 1 U1, user 2 U2, and user 3 U3 for each of regions Room 1, Room 2, Room 3, and Room 4. FIG. 12 is a view illustrating the traveling map indicating the regions in the house in which the robot travels in the example situation in FIG. 11 and illustrating the locations of the registered users. FIG. 13 is a view illustrating how the location probability is updated depending on whether the robot has recognized the user in the example situation in FIGS. 11 and 12.

With reference to FIG. 11, user 1 U1 has the highest probability of being located in room 2, user 2 U2 has the highest probability of being located in room 2, and user 3 U3 has the highest probability of being located in room 4.

As illustrated in FIG. 12, user 1 is detected by the sensor part 600 of the robot 1 while the robot 1 travels or is on standby in current room 1.

The robot 1 may update the location probability for detected user 1 U1 in room 1 to 100%. Because user 1 U1 has detected in room 1, all the location probabilities of the remaining regions (room 2, room 3, and room 4) are updated to 0%.

The robot 1 may update the location probability for user 2 U2, who is not detected in room 1, to 0%. Because the location probability for user 2 U2 in room 1 has been 30%, the location probabilities of the remaining regions (room 2, room 3, and room 4) are increased by the same amount (10%) by the decreased value of 30. That is, the location probability of room 2 may be updated from 40 to 50, the location probability of room 3 may be updated from 30 to 40, and the location probability of room 4 may be updated from 0 to 10.

Because user 3 U3 has also not been detected in room 1 but the initial location probability of room 1 has been 0, the location probability is maintained in an intact manner. Because the location probability in room 1 in the current region has not been updated, the location probabilities of the remaining regions (room 2, room 3, and room 4) are also maintained in an intact manner.

If an instruction, which is related to user 2 U2 as the target user, is inputted to the robot 1 in a state in which the location probability has been updated as illustrated in FIG. 13, the robot 1 may create the movement route in the order of room 2→room 3→room 4.

If an instruction, which is related to user 3 U3 as the target user, is inputted to the robot 1 in a state in which the location probability has been updated as illustrated in FIG. 13, the robot 1 may create the movement route in the order of room 4→room 3→room 2.

After the robot 1 moves from one region to another region to execute the instruction, the location probabilities for all the users may be updated again depending on the state in which the robot 1 detects or does not detect the target user or a registered user who is not the target user.

That is, the location probability may be updated in real time depending on whether the user is detected. In another embodiment, the location probability may be updated depending on whether the user is detected each time the robot 1 moves to change the region.

As described above, in the embodiment of the present disclosure, because the location probability for the user is updated in real time or each time the robot 1 moves, the accuracy of the location probability for the user may be maintained to be high at ordinary times.

Meanwhile, the controller 700 may control the movement of the robot 1 so that the robot 1 directly searches for the corresponding user in case that the highest location probability for any registered particular user is lower than a preset value (predetermined reliability value). The location probability may be updated by means of direct search. The direct search may be performed in descending order of the location probability. For example, in case that the value of the highest location probability is smaller than 80%, the robot 1 may travel to directly search for the corresponding user.

As described above, a value (predetermined reliability value) of the location probability, which is set to be reliable, is determined, and the location probability is updated as the robot 1 directly searches for the user in case that the highest location probability is smaller than the value, such that the accuracy of the location probability may be maintained at a reliably high level at ordinary times. In the embodiment illustrated in FIG. 13, in case that the preset predetermined reliability value is 80%, the robot 1 moves to directly search for user 2 U2. Because the location probabilities for the remaining users U1 and U3 are respectively 100 and 80, i.e., have high reliability levels, such that the users are not directly searched.

In another embodiment, the controller 700 may control the movement of the robot 1 to directly search for any user and update the location probability each time a preset period of time elapses. In the present embodiment, the robot 1 may periodically, e.g., once every hour, update the location probability for the detected user while traveling as if patrolling a predetermined movement route.

As described above, the location probability for any user is updated by means of the periodic search, such that the accuracy of the location probability for the user may be maintained to be high at ordinary times.

The controller 700 may update the location probability for the corresponding user to a non-identifiable state in case that all the location probabilities for the user in the respective distinguished regions are 0%.

In case that the robot 1 performs the periodic search, all the location probabilities for any user may be sometimes updated to 0%. For example, as shown in the table in FIG. 13, after the location probability is updated, the robot 1 may travel in the order of room 2→room 3→room 4, and user 2 may not be detected anywhere. In the state in which user 2 is not detected in room 3, the location probability of room 4, which is the last visited region, would be updated to 100%. However, if user 2 is not detected in room 4 even though user 2 visits room 4, the location probabilities of the all the regions may be updated to 0% instead of updating the location probability of room 4 to 0% and increasing the location probability of the remaining regions.

In this case, the controller 700 may update the location of user 2 to a non-identifiable state.

That is, in case that the periodic search is performed or in case that the location probabilities of all the regions are updated within a short period of time like a case in which the robot travels toward the target user, in other words, in case that the location probabilities of all the regions are updated for a predetermined period of time, no user may be detected in the visited region.

In this case, that is, the maintaining of the sum of the location probabilities as 100% even in case that all the regions are searched within a short time is meaningless. In this case, because the probability of the user being absent is high, the detection result may be applied in an intact manner without maintaining the sum of the location probabilities as 100%.

If the result of searching for all the regions indicates that all the location probabilities are 0%, the state of the corresponding user may be determined to be in a non-identifiable state.

Thereafter, when the user, which is determined to be in the non-identifiable state, inputs an instruction related to the target user to the robot 1, the robot 1 may provide the user who has issued the instruction with a message indicating that the location of the target user cannot be identified. For example, voice messages such as “XX seems to be out,” “XX seems to be away,” or “The current location of XX cannot be identified, so the instruction cannot be executed” may be sent.

Meanwhile, a main region with the highest probability of location may be designated for each of the registered users. A matching state between the user and the main region may be registered in the memory 720. In a possible embodiment, the main region may be set in advance in the robot 1 by the user. In another possible embodiment, the main region may be calculated on the basis of statistical values of the location probability for a certain period of time.

In the embodiment in which the main region is registered, when the location probability is updated for each of the users, the controller 700 may apply different ratios to the increase or decrease in the location probability between the main region and another region.

For example, when the robot 1, which travels in room 2, cannot user 1 in room 2 in case that the main region of user 1 is room 1, the location probability for user 1 in room 2 may be updated to 0%, the location probabilities of room 1, room 3, and room 4 may be increased, and the location probability of room 1, which is the main region, may be increased at a higher rate.

In most households, each user has a designated region where the user primarily spends his/her time. Therefore, the main region may be registered, and the location probability is updated on the basis of the main region, which may further assist in improving the accuracy of the location probability for the user.

Meanwhile, in case that the robot 1 moves toward the target user related to the instruction to be executed, the robot 1 may be present in a currently inaccessible region that is the registered region. For example, this case corresponds to a case in which the robot 1 cannot enter room 2 because the door of room 2 is closed when the robot 1 is intended to move from room 1 to room 2.

This inaccessible state may occur not only a case in which the robot 1 moves to execute the instruction but also a case in which the robot 1 moves to periodically search for the user and a case in which the robot 1 moves to update the location probability for the particular user.

The controller 700 may update the location probability by using voice recognition in case that the robot 1 cannot enter any region. For example, in case that the robot 1 cannot enter room 2, it is possible to inquire about whether any user is currently present in room 2. In this case, when the particular user responds, the controller 700 may determine which user is located in room 2 by using voice recognition.

On the basis of this configuration, the user, who has responded, may be determined as being detected in the corresponding region, the user, who has not responded, may be determined as not being detected in the corresponding region, and the location probability may be updated.

Any flowcharts, flow diagrams, state transition diagrams, pseudo-code, and the like described in the present disclosure are substantially expressed in a computer-readable medium and represent various processes that may be executed by a computer or processor, whether the computer or processor is explicitly shown or not, and this will be recognized by those skilled in the art.

Therefore, the embodiments described above may be written as programs that may be executed on a computer and may be implemented on a general-purpose digital computer that operates the program by using a computer-readable recording medium. The computer-readable recording media may include storage media such as magnetic storage media (e.g., ROMs, floppy discs, hard discs, etc.) and optical readout media (e.g., CD-ROMs, DVDs, etc.).

The functions of various elements illustrated in the drawings may be provided through the use of dedicated hardware as well as hardware capable of executing the appropriate software. When provided by a processor, these functions may be provided by a single dedicated processor, a single shared processor, or a plurality of individual processors, some of which may be shared.

Furthermore, the explicit use of the terms “processor” or “control unit” should not be interpreted as exclusively referring to hardware capable of executing software, but may implicitly include, without limitation, digital signal processor (DSP) hardware, read-only memory (ROM) for storing software, random access memory (RAM), and non-volatile storage devices.

While the specific embodiments of the present disclosure have been described and illustrated, it is obvious to those skilled in the art that the present disclosure is not limited to the aforementioned embodiments and may be variously changed and modified without departing from the spirit and the scope of the present disclosure. Therefore, the scope of the present disclosure should be determined by the technical spirit of the appended claims instead of being determined by the described embodiment.

1. A robot comprising:
a robot main body configured to accommodate a battery therein;
a wheel part disposed below the robot main body and configured to move the robot main body in a house while rotating;
a sensor part disposed on the robot main body and configured to detect a user located outside the robot main body;
a memory disposed in the robot main body and configured to store location probabilities indicating probabilities that a plurality of pre-registered users are located in distinguished regions in the house; and
a controller disposed in the robot main body and configured to update the location probability depending on whether the user is detected at a current location.

2. The robot of claim 1, wherein the controller creates a movement route along which the robot visits the regions in descending order of the location probability for a target user when the robot moves toward the target user related to an instruction to be executed.

3. The robot of claim 1, wherein the controller maintains a value made by adding up the location probabilities of the distinguished regions as 100% when the location probability is updated.

4. The robot of claim 1, wherein when the user is detected by the sensor part in the current region in which the robot main body is located, the controller updates the location probability for the detected user in the current region to 100%.

5. The robot of claim 1, wherein when the user is not detected by the sensor part in the current region in which the robot main body is located, the controller updates the location probability for the user, who is not detected, in the current region to 0%.

6. The robot of claim 5, wherein when the location probability of the current region is updated to 0%, the controller performs the update by increasing the location probabilities of the remaining spaces excluding the current region by the same amount.

7. The robot of claim 1, wherein when the highest location probability for any particular user is lower than a preset value, the controller moves the robot main body by controlling the wheel part to directly search for the corresponding user and update the location probability.

8. The robot of claim 1, wherein the controller moves the robot main body by controlling the wheel part to directly search for any user and update the location probability each time a preset period of time elapses.

9. The robot of claim 1, wherein when all the location probabilities for any user in the distinguished regions are 0%, the controller determines a location of the corresponding user as a non-identifiable state.

10. The robot of claim 1, wherein the controller designates a main region having the highest probability that the user is located, and the controller applies different ratios to the increase or decrease in the location probability between the main region and another region when the location probability is updated for each user.

11. The robot of claim 1, wherein when the robot moves toward a target user related to an instruction to be executed, the controller updates the location probability by using voice recognition when an inaccessible region is present in the distinguished regions.
